(19) United States
(12) Patent Application Publication
(10) Pub. No.: US 2017/0362549 A1
(43) Pub. Date: Dec. 21, 2017

(54) LIQUID DETERGENT COMPOSITION

(71) Applicant: The Procter & Gamble Company, Cincinnati, OH (US)

(72) Inventors: Karl Ghislain BRAECKMAN, Gerpinnes (BE); Sergio RODRIGUEZ RODRIGUEZ, Brussels (BE); Patrick Firmin August DELPLANCKE, Steenhuize-Wijnhuize (BE); Robby Renilde Francois KEULEERS, Lippelo (Sint Amands) (BE)

(21) Appl. No.: 15/620,087

(22) Filed: Jun. 12, 2017

(30) Foreign Application Priority Data
Jun. 17, 2016 (EP) 16175146.6

(51) Int. Cl. C11D 11/00; C11D 1/83; C11D 3/37; C11D 3/30; C11D 1/29; C11D 1/75

(52) U.S. Cl. CPC C11D 11/0023; C11D 3/3707; C11D 3/30; C11D 1/83; C11D 1/75; C11D 1/29

(57) ABSTRACT

A hand dishwashing detergent composition including anionic surfactant and an amine oxide surfactant including a low-cut amine oxide of formula RaRbRcAO wherein Ra and Rb are independently selected from hydrogen, C1-C4 alkyls or mixtures thereof and wherein Rc is selected from C10 alkyls or mixtures thereof, and a cleaning amine.

### FIELD OF THE INVENTION

The present invention relates to a hand dishwashing detergent composition comprising anionic surfactant, low-cut amine oxide and a cleaning amine. The composition provides improved cleaning and foaming properties and present good stability.

### BACKGROUND OF THE INVENTION

Hand dishwashing detergent compositions should have a good suds profile while providing good soil and grease cleaning. However, a dichotomy exists between some cleaning technologies that are good for grease cleaning but impair on suds.

Users usually see foam as an indicator of the performance of the detergent composition. Moreover, the user of a hand dishwashing detergent composition also uses the sudsing profile and the appearance of the foam (density, whiteness) as an indicator that the wash solution or cleaning implement still contains active detergent ingredients. The user usually doses the dishwashing detergent depending on the foam ability and renews the wash solution when the suds subsides or when the foam does not look strong enough. Thus, a wash liquor comprising a dishwashing detergent composition that generates little foam would tend to be replaced by the user more frequently than it is necessary. Hand dishwashing detergent compositions need to provide good grease cleaning and to exhibit good foam height and appearance as well as good foam generation during the initial mixing of the detergent with water and good lasting foam during the entire manual dishwashing operation.

There is a need to provide hand dishwashing compositions with improved foam properties while at the same time providing improved grease cleaning.

### SUMMARY OF THE INVENTION

According to a first aspect of the invention, there is provided a hand dishwashing detergent composition. The composition comprises anionic surfactant, amine oxide surfactant comprising a low-cut amine oxide and a cleaning amine selected from the group consisting of:

i. polyetheramines of Formula (I), Formula (II), or Formula (III):

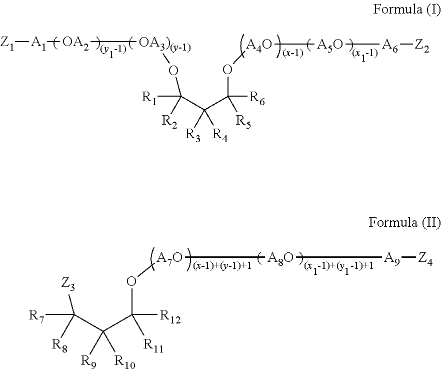

wherein each of R₁-R₁₂ is independently selected from H, alkyl, cycloalkyl, aryl, alkylaryl, or arylalkyl, wherein at least one of R₁-R₆ and at least one of R₇-R₁₂ is different from H, each of A₁-A₉ is independently selected from linear or branched alkylenes having 2 to 18 carbon atoms, each of Z₁-Z₄ is independently selected from OH or NH₂, wherein at least one of Z₁-Z₂ and at least one of Z₃-Z₄ is NH₂, wherein the sum of x+y is in the range of about 2 to about 200, wherein x≧1 and y≧1, and the sum of x₁+y₁ is in the range of about 2 to about 200, wherein x₁≧1 and y₁≧1;

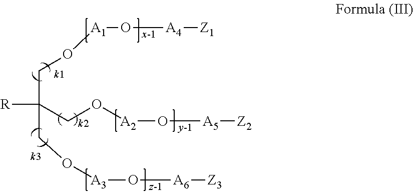

wherein
R is selected from H or a C1-C6 alkyl group, each of k₁, k₂, and k₃ is independently selected from 0, 1, 2, 3, 4, 5, or 6, each of A₁, A₂, A₃, A₄, A₅, and A₆ is independently selected from a linear or branched alkylene group having from 2 to 18 carbon atoms or mixtures thereof, x≧1, y≧1, and z≧1, and the sum of x+y+z is in the range of from about 3 to about 100, each of Z₁, Z₂, and Z₃ is independently selected from NH₂ or OH, where at least two of Z₁, Z₂, and Z₃ are NH₂; and the polyetheramine has a weight average molecular weight of from about 150 to about 1000 grams/mole;
ii. amines of Formula (1)

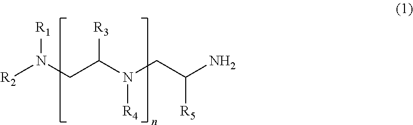

wherein: R₁, R₂, R₃, R₄, and R₅ are independently selected from —H, linear, branched or cyclic alkyl or alkenyl having from 1 to 10 carbon atoms and n=0-3;
iii. amines of Formula (2):

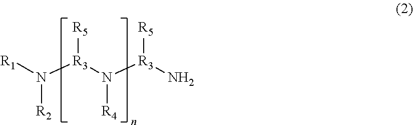

wherein R₁ and R₄ are independently selected from —H, linear, branched or cyclic alkyl or alkenyl having from 1 to 10 carbon atoms; and R₂ is a linear, branched or cyclic alkyl or alkenyl having from 3 to 10 carbons, R₃ is a linear or branched alkyl from 3 to 6 carbon atoms, R₅ is H, methyl or ethyl and n=0-3;
iv. the amine of Formula (3):

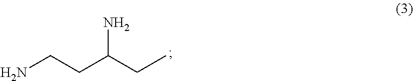

and
v. mixtures thereof.

The composition preferably comprises from about 1 to about 15%, preferably from 1.5 to about 10%, more preferably from about 2 to about 8% by weight of the composition of amine oxide surfactant. The amine oxide surfactant can be a mixture of amine oxides comprising a low-cut amine oxide and a mid-cut amine oxide.

The low-cut amine oxide of the composition of the invention has the formula RaRbRcAO wherein Ra and Rb are independently selected from hydrogen, C1-C4 alkyls or mixtures thereof and wherein Rc is selected from C10 alkyls or mixtures thereof. The composition optionally comprises a mid-cut amine oxide of formula RdReRfAO wherein Rd and Re are independently selected from hydrogen, C1-C4 alkyls or mixtures thereof and wherein Rf is selected from C12-C16 alkyls or mixtures thereof.

The composition of the invention provides good cleaning and good suds profile. It presents benefits in terms of tough food cleaning (cooked-, baked- and burnt-on soils) and grease cleaning.

When the composition of the invention is in use, the appearance of the suds is very appealing. The suds are constituted by airy bubbles that seem to travel very quickly from the cleaning implement to the items to be cleaned. This is believed to contribute to a faster and better cleaning.

In a preferred low-cut amine oxide for use herein Rc is n-decyl. In another preferred low-cut amine oxide for use herein Ra and Rb are both methyl. In an especially preferred low-cut amine oxide for use herein Ra and Rb are both methyl and Rc is n-decyl.

Preferably, the amine oxide comprises less than about 5%, more preferably less than 3% by weight of the amine oxide of an amine oxide of formula RgRhRiAO wherein Rg and Rh are independently selected from hydrogen, C1-C4 alkyls or mixtures thereof and wherein Ri is selected from C8 alkyls or mixtures thereof. Compositions comprising RgRhRiAO tend to be unstable and do not provide very suds mileage.

The composition of the invention comprises anionic surfactant, the anionic surfactant can be any anionic cleaning surfactant, preferably the anionic surfactant comprises a sulphate anionic surfactant, more preferably an alkyl sulphate and/or alkoxylated sulfate anionic surfactant, preferably an alkyl alkoxylated sulphate, preferably the alkoxylated anionic surfactant has an average alkoxylation degree of from about 0.2 to about 3, preferably from about 0.2 to about 2, most preferably from about 0.2 to about 1.0. Also preferred are branched anionic surfactants having a weight average level of branching of from about 5% to about 40%.

Preferably the composition of the invention comprises from about 1% to about 60%, preferably from about 5% to about 50%, more preferably from about 8% to about 40% by weight of the composition of total surfactant. Preferably the composition of the invention comprises from about 5% to about 40% by weight of the composition of anionic surfactant, more preferably from about 8% to about 35%, yet more preferably from about 10% to about 30%.

Preferably the anionic surfactant and the amine oxide are in a weight ratio of from about 1:1 to about 10:1. Preferred anionic surfactant amine oxide weight ratio have been found to be from 2:1 to 5:1 and from 5:1 to 10:1. Compositions in which the anionic surfactant and the amine oxide surfactant are in these ratios present very good cleaning and suds mileage.

Preferably, the composition of the invention comprises less than about 2%, more preferably less than 1% by weight of the composition of non-ionic surfactants. It has been found that the compositions with this low level of non-ionic surfactant can provide a more robust cleaning system.

According to the second aspect of the invention, there is provided a process for making the dishwashing detergent of the invention comprising a low-cut and a mid-cut amine oxide. The process requires the use of two different streams one comprising the low-cut amine oxide and another comprising the mid-cut amine oxide.

For the purpose of this invention “dishware” herein includes cookware and tableware.

### DETAILED DESCRIPTION OF THE INVENTION

### Definition

As used herein, the singular forms “a”, “an”, and “the” include both singular and plural referents unless the context clearly dictates otherwise.

The term “about” or “approximately” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” or “approximately” refers is itself also specifically, and preferably, disclosed.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

In all embodiments of the present invention, all percentages are by weight of the total composition, as evident by the context, unless specifically stated otherwise. All ratios are weight ratios, unless specifically stated otherwise, and all measurements are made at 25° C., unless otherwise designated.

The present invention envisages a hand dishwashing detergent composition. Preferably in liquid form. The detergent composition comprises a surfactant system comprising anionic surfactant and amine oxide surfactant and a cleaning amine. It provides very good cleaning, especially grease cleaning. It is also good for tough food cleaning, including cook-, baked- and burnt-on cleaning. It provides very good suds mileage and suds profile.

### The Detergent Composition

The detergent composition is a hand dishwashing detergent, preferably in liquid form. It typically contains from 30% to 95%, preferably from 40% to 90%, more preferably from 50% to 85% by weight of the composition of a liquid carrier in which the other essential and optional components are dissolved, dispersed or suspended. One preferred component of the liquid carrier is water.

Preferably the pH of the composition is adjusted to be from between 6 and 10, more preferably between 6.5 and 9.5, even more preferably between 7 and 9, most preferably between 7.5 and 8.5. The pH is measured as a 10 wt % product solution in deionised water at 20° C. The pH of the composition can be adjusted using pH modifying ingredients known in the art.

The composition can comprises 1% to 60%, preferably from 5% to 50%, more preferably from 8% to 40% of total surfactant. In addition to the anionic and amine oxide surfactant the composition can optionally comprise non-ionic surfactant, zwitterionic and/or cationic surfactant.

### Amine Oxide Surfactant

The amine oxide surfactant improves the cleaning and boosts the suds of the detergent composition. This improved cleaning and suds boosting is achieved by the combination of the anionic surfactant and amine oxide and the presence of low cut amine oxide surfactant at the claimed level.

### Low-Cut Amine Oxide

Within the meaning of the present invention “low-cut amine oxide” means an amine oxide in which at least 90%, preferably at least 95% and more preferably at least 98% and especially at least 100% of the cut has the formula: RaRbRcAO wherein Ra and Rb are independently selected from hydrogen, C1-C4 alkyls or mixtures thereof and wherein Rc is selected from C10 alkyls or mixtures thereof.

### Mid-Cut Amine Oxide

Within the meaning of the present invention “mid-cut amine oxide” means an amine oxide in which at least 90%, preferably at least 95% and more preferably at least 98% and especially at least 100% of the cut has the formula: RdReRfAO wherein Rd and Re are independently selected from hydrogen, C1-C4 alkyls or mixtures thereof and wherein Rf is selected from C12-C16 alkyls or mixtures thereof.

### Anionic Surfactant

Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a C 8-C 22 alkyl, or acyl group. Such surfactants are employed in the form of water-soluble salts and the salt-forming cation usually is selected from sodium, potassium, ammonium, magnesium and mono-, di- or tri-alkanolammonium, with the sodium, cation being the usual one chosen.

The anionic surfactant can be a single surfactant but usually it is a mixture of anionic surfactants. Preferably the anionic surfactant comprises a sulphate surfactant, more preferably a sulphate surfactant selected from the group consisting of alkyl sulphate, alkyl alkoxy sulphate and mixtures thereof. Preferred alkyl alkoxy sulphates for use herein are alkyl ethoxy sulphates.

Preferably the anionic surfactant is alkoxylated, more preferably, an alkoxylated branched anionic surfactant having an alkoxylation degree of from about 0.2 to about 4, even more preferably from about 0.3 to about 3, even more preferably from about 0.4 to about 1.5 and especially from about 0.4 to about 1. Preferably, the alkoxy group is ethoxy. When the branched anionic surfactant is a mixture of surfactants, the alkoxylation degree is the weight average alkoxylation degree of all the components of the mixture (weight average alkoxylation degree). In the weight average alkoxylation degree calculation the weight of anionic surfactant components not having alkoxylated groups should also be included.

Weight average alkoxylation degree=(x1*alkoxylation degree of surfactant 1+x2*alkoxylation degree of surfactant 2+ . . . )/(x1+x2+ . . . )

wherein x1, x2, . . . are the weights in grams of each anionic surfactant of the mixture and alkoxylation degree is the number of alkoxy groups in each anionic surfactant.

Preferably the anionic surfactant to be used in the detergent of the present invention is a branched anionic surfactant having a level of branching of from about 5% to about 40%, preferably from about 10 to about 35% and more preferably from about 20% to about 30%. Preferably, the branching group is an alkyl. Typically, the alkyl is selected from methyl, ethyl, propyl, butyl, pentyl, cyclic alkyl groups and mixtures thereof. Single or multiple alkyl branches could be present on the main hydrocarbyl chain of the starting alcohol(s) used to produce the anionic surfactant used in the detergent of the invention. Most preferably the branched anionic surfactant is selected from alkyl sulphates, alkyl ethoxy sulphates, and mixtures thereof.

The branched anionic surfactant can be a single anionic surfactant or a mixture of anionic surfactants. In the case of a single surfactant the percentage of branching refers to the weight percentage of the hydrocarbyl chains that are branched in the original alcohol from which the surfactant is derived.

In the case of a surfactant mixture the percentage of branching is the weight average and it is defined according to the following formula:

Weight average of branching (%)=[(x1*wt % branched alcohol 1 in alcohol 1+x2*wt % branched alcohol 2 in alcohol 2+ . . . )/(x1+x2+ . . . )]*100

wherein x1, x2, . . . are the weight in grams of each alcohol in the total alcohol mixture of the alcohols which were used as starting material for the anionic surfactant for the detergent of the invention. In the weight average branching degree calculation the weight of anionic surfactant components not having branched groups should also be included.

Preferably, the anionic surfactant is a branched anionic surfactant having a level of branching of from about 5% to about 40%, preferably from about 10 to about 35% and more preferably from about 20% to about 30%, more preferably the branched anionic surfactant comprises more than 50% by weight thereof of an alkyl ethoxylated sulphate. Preferably the branched anionic surfactant has an average ethoxylation degree of from about 0.2 to about 3 and preferably an average level of branching of from about 5% to about 40%.

Preferably, the anionic surfactant comprises at least 50%, more preferably at least 60% and preferably at least 70% by weight of the anionic surfactant, more preferably the branched anionic surfactant comprises more than 50% by weight thereof of an alkyl ethoxylated sulphate having an ethoxylation degree of from about 0.2 to about 3 and preferably a level of branching of from about 5% to about 40%.

### Sulphate Surfactants

Suitable sulphate surfactants for use herein include water-soluble salts of C8-C18 alkyl or hydroxyalkyl, sulphate and/or ether sulfate. Suitable counterions include alkali metal cation or ammonium or substituted ammonium, but preferably sodium.

The sulphate surfactants may be selected from C8-C18 primary, branched chain and random alkyl sulphates (AS); C8-C18 secondary (2,3) alkyl sulphates; C8-C18 alkyl alkoxy sulphates (AExS) wherein preferably x is from 1-30 in which the alkoxy group could be selected from ethoxy, propoxy, butoxy or even higher alkoxy groups and mixtures thereof.

Alkyl sulfates and alkyl alkoxy sulfates are commercially available with a variety of chain lengths, ethoxylation and branching degrees. Commercially available sulphates include, those based on Neodol alcohols ex the Shell company, Lial—Isalchem and Safol ex the Sasol company, natural alcohols ex The Procter & Gamble Chemicals company.

Preferably, the branched anionic surfactant comprises at least 50%, more preferably at least 60% and especially at least 70% of a sulphate surfactant by weight of the branched anionic surfactant. Especially preferred detergents from a cleaning view point art those in which the branched anionic surfactant comprises more than 50%, more preferably at least 60% and especially at least 70% by weight thereof of sulphate surfactant and the sulphate surfactant is selected from the group consisting of alkyl sulphate, alkyl ethoxy sulphates and mixtures thereof. Even more preferred are those in which the branched anionic surfactant has a degree of ethoxylation of from about 0.2 to about 3, more preferably from about 0.3 to about 2, even more preferably from about 0.4 to about 1.5, and especially from about 0.4 to about 1 and even more preferably when the anionic surfactant has a level of branching of from about 10% to about 35%, %, more preferably from about 20% to 30%.

### Sulphonate Surfactants

Suitable sulphonate surfactants for use herein include water-soluble salts of C8-C18 alkyl or hydroxyalkyl sulphonates; C11-C18 alkyl benzene sulphonates (LAS), modified alkylbenzene sulphonate (MLAS) as discussed in WO 99/05243, WO 99/05242, WO 99/05244, WO 99/05082, WO 99/05084, WO 99/05241, WO 99/07656, WO 00/23549, and WO 00/23548; methyl ester sulphonate (MES); and alpha-olefin sulphonate (AOS). Those also include the paraffin sulphonates may be monosulphonates and/or disulphonates, obtained by sulphonating paraffins of 10 to 20 carbon atoms. The sulfonate surfactant also include the alkyl glyceryl sulphonate surfactants.

### Cleaning Amine

The composition described herein includes from about 0.1% to about 10%, preferably, from about 0.2% to about 5%, and more preferably, from about 0.5% to about 4%, by weight of the composition, of a cleaning amine.

The term “cleaning amine” herein encompasses a single cleaning amine and a mixture thereof. A “cleaning amine” herein means a molecule comprising amine functionalities that helps cleaning as part of a cleaning composition.

The amine can be subjected to protonation depending on the pH of the cleaning medium in which it is used.

Cleaning amines for use herein include polyetheramines. One of the polyetheramine preferred for use in the composition of the invention is represented by the structure of Formula (I):

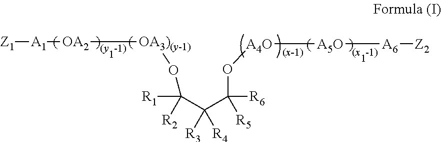

where each of R₁-R₆ is independently selected from H, alkyl, cycloalkyl, aryl, alkylaryl, or arylalkyl, where at least one of R₁-R₆ is different from H, typically at least one of R₁-R₆ is an alkyl group having 2 to 8 carbon atoms, each of A₁-A₆ is independently selected from linear or branched alkylenes having 2 to 18 carbon atoms, each of Z₁-Z₂ is independently selected from OH or NH₂, where at least one of Z₁-Z₂ is NH₂, typically each of Z₁ and Z₂ is NH₂, where the sum of x+y is in the range of about 2 to about 200, typically about 2 to about 20, more typically about 2 to about 10 or about 3 to about 8 or about 4 to about 6, where x≧1 and y≧1, and the sum of x₁+y₁ is in the range of about 2 to about 200, typically about 2 to about 20, more typically about 2 to about 10 or about 3 to about 8 or about 2 to about 4, where x₁≧1 and y₁≧1.

Preferably in the polyetheramine of Formula (I), each of A₁-A₆ is independently selected from ethylene, propylene, or butylene, typically each of A₁-A₆ is propylene. More preferably, in the polyetheramine of Formula (I), each of R₁, R₂, R₅, and R₆ is H and each of R₃ and R₄ is independently selected from C1-C16 alkyl or aryl, typically each of R₁, R₂, R₅, and R₆ is H and each of R₃ and R₄ is independently selected from a butyl group, an ethyl group, a methyl group, a propyl group, or a phenyl group. More preferably, in the polyetheramine of Formula (I), R₃ is an ethyl group, each of R₁, R₂, R₅, and R₆ is H, and R₄ is a butyl group. Especially, in the polyetheramine of Formula (I), each of R₁ and R₂ is H and each of R₃, R₄, R₅, and R₆ is independently selected from an ethyl group, a methyl group, a propyl group, a butyl group, a phenyl group, or H.

In the polyetheramine represented by the structure of Formula (II):

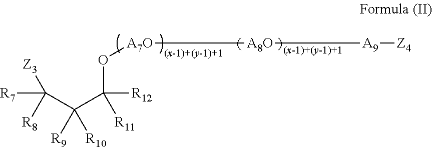

each of R₇-R₁₂ is independently selected from H, alkyl, cycloalkyl, aryl, alkylaryl, or arylalkyl, where at least one of R₇-R₁₂ is different from H, typically at least one of R₇-R₁₂ is an alkyl group having 2 to 8 carbon atoms, each of A₇-A₉ is independently selected from linear or branched alkylenes having 2 to 18 carbon atoms, each of Z₃-Z₄ is independently selected from OH or NH₂, where at least one of Z₃-Z₄ is NH₂, typically each of Z₃ and Z₄ is NH₂, where the sum of x+y is in the range of about 2 to about 200, typically about 2 to about 20, more typically about 2 to about 10 or about 3 to about 8 or about 2 to about 4, where x≧1 and y≧1, and the sum of x₁+y₁ is in the range of about 2 to about 200, typically about 2 to about 20, more typically about 2 to about 10 or about 3 to about 8 or about 2 to about 4, where x₁≧1 and y₁≧1.

Preferably in the polyetheramine of Formula (II), each of A₇-A₉ is independently selected from ethylene, propylene, or butylene, typically each of A₇-A₉ is propylene. More preferably, in the polyetheramine of Formula (II), each of R₇, R₈, R₁₁, and R₁₂ is H and each of R₉ and R₁₀ is independently selected from C1-C16 alkyl or aryl, typically each of R₇, R₈, R₁₁, and R₁₂ is H and each of R₉ and R₁₀ is independently selected from a butyl group, an ethyl group, a methyl group, a propyl group, or a phenyl group. More preferably, in the polyetheramine of Formula (II), R₉ is an ethyl group, each of R₇, R₈, R₁₁, and R₁₂ is H, and R₁₀ is a butyl group. In some aspects, in the polyetheramine of Formula (II), each of R₇ and R₈ is H and each of R₉, R₁₀, R₁₁, and R₁₂ is independently selected from an ethyl group, a methyl group, a propyl group, a butyl group, a phenyl group, or H.

Preferred polyetheramines are selected from the group consisting of Formula A, Formula B, and mixtures thereof:

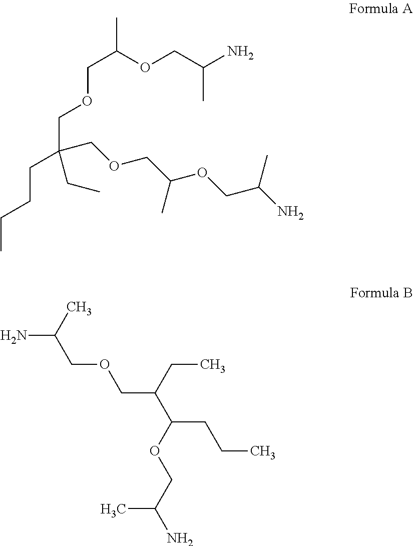 [SMILES: CCCCC(CC)(COCC(C)OCC(C)N)COCC(C)OCC(C)N ; CCCC(OCC(C)N)C(CC)COCC(C)N]

Preferably, the polyetheramine comprises a mixture of the compound of Formula (I) and the compound of Formula (II).

Typically, the polyetheramine of Formula (I) or Formula (II) has a weight average molecular weight of less than about grams/mole 1000 grams/mole, preferably from about 100 to about 800 grams/mole, more preferably from about 200 to about 450 grams/mole.

The polyetheramine can comprise a polyetheramine mixture comprising at least 90%, by weight of the polyetheramine mixture, of the polyetheramine of Formula (I), the polyetheramine of Formula (II), the polyetheramine of Formula (III) or a mixture thereof. Preferably, the polyetheramine comprises a polyetheramine mixture comprising at least 95%, by weight of the polyetheramine mixture, of the polyetheramine of Formula (I), the polyetheramine of Formula (II) and the polyetheramine of Formula (III).

The polyetheramine of Formula (I) and/or the polyetheramine of Formula (II), are obtainable by:

a) reacting a 1,3-diol of formula (1) with a C₂-C₁₈ alkylene oxide to form an alkoxylated 1,3-diol, wherein the molar ratio of 1,3-diol to C₂-C₁₈ alkylene oxide is in the range of about 1:2 to about 1:10,

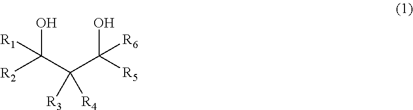

where R₁-R₆ are independently selected from H, alkyl, cycloalkyl, aryl, alkylaryl, or arylalkyl, where at least one of R₁-R₆ is different from H;
b) aminating the alkoxylated 1,3-diol with ammonia.

The molar ratio of 1,3-diol to C₂-C₁₈ alkylene oxide is preferably in the range of about 1:3 to about 1:8, more typically in the range of about 1:4 to about 1:6. Preferably, the C₂-C₁₈ alkylene oxide is selected from ethylene oxide, propylene oxide, butylene oxide or a mixture thereof. More preferably, the C₂-C₁₈ alkylene oxide is propylene oxide.

In the 1,3-diol of formula (1), R₁, R₂, R₅, and R₆ are H and R₃ and R₄ are C₁₋₁₆ alkyl or aryl. Preferably, the 1,3-diol of formula (1) is selected from 2-butyl-2-ethyl-1,3-propanediol, 2-methyl-2-propyl-1,3-propanediol, 2-methyl-2-phenyl-1,3-propanediol, 2,2-dimethyl-1,3-propandiol, 2-ethyl-1,3-hexandiol, or a mixture thereof.

### Step a): Alkoxylation

The 1,3-diols of Formula (1) are synthesized as described in WO10026030, WO10026066, WO09138387, WO09153193, and WO10010075. Suitable 1,3-diols include 2,2-dimethyl-1,3-propane diol, 2-butyl-2-ethyl-1,3-propane diol, 2-pentyl-2-propyl-1,3-propane diol, 2-(2-methyl)butyl-2-propyl-1,3-propane diol, 2,2,4-trimethyl-1,3-propane diol, 2,2-diethyl-1,3-propane diol, 2-methyl-2-propyl-1,3-propane diol, 2-ethyl-1,3-hexane diol, 2-phenyl-2-methyl-1,3-propane diol, 2-methyl-1,3-propane diol, 2-ethyl-2-methyl-1,3 propane diol, 2,2-dibutyl-1,3-propane diol, 2,2-di(2-methylpropyl)-1,3-propane diol, 2-isopropyl-2-methyl-1,3-propane diol, or a mixture thereof. In some aspects, the 1,3-diol is selected from 2-butyl-2-ethyl-1,3-propanediol, 2-methyl-2-propyl-1,3-propanediol, 2-methyl-2-phenyl-1,3-propanediol, or a mixture thereof. Typically used 1,3-diols are 2-butyl-2-ethyl-1,3-propanediol, 2-methyl-2-propyl-1,3-propanediol, 2-methyl-2-phenyl-1,3-propanediol.

An alkoxylated 1,3-diol may be obtained by reacting a 1,3-diol of Formula I with an alkylene oxide, according to any number of general alkoxylation procedures known in the art. Suitable alkylene oxides include C₂-C₁₈ alkylene oxides, such as ethylene oxide, propylene oxide, butylene oxide, pentene oxide, hexene oxide, decene oxide, dodecene oxide, or a mixture thereof. In some aspects, the C₂-C₁₈ alkylene oxide is selected from ethylene oxide, propylene oxide, butylene oxide, or a mixture thereof. A 1,3-diol may be reacted with a single alkylene oxide or combinations of two or more different alkylene oxides. When using two or more different alkylene oxides, the resulting polymer may be obtained as a block-wise structure or a random structure.

Typically, the molar ratio of 1,3-diol to C₂-C₁₈ alkylene oxide at which the alkoxylation reaction is carried out is in the range of about 1:2 to about 1:10, more typically about 1:3 to about 1:8, even more typically about 1:4 to about 1:6.

The alkoxylation reaction generally proceeds in the presence of a catalyst in an aqueous solution at a reaction temperature of from about 70° C. to about 200° C. and typically from about 80° C. to about 160° C. The reaction may proceed at a pressure of up to about 10 bar or up to about 8 bar. Examples of suitable catalysts include basic catalysts, such as alkali metal and alkaline earth metal hydroxides, e.g., sodium hydroxide, potassium hydroxide and calcium hydroxide, alkali metal alkoxides, in particular sodium and potassium C₁-C₄-alkoxides, e.g., sodium methoxide, sodium ethoxide and potassium tert-butoxide, alkali metal and alkaline earth metal hydrides, such as sodium hydride and calcium hydride, and alkali metal carbonates, such as sodium carbonate and potassium carbonate. In some aspects, the catalyst is an alkali metal hydroxides, typically potassium hydroxide or sodium hydroxide. Typical use amounts for the catalyst are from about 0.05 to about 10% by weight, in particular from about 0.1 to about 2% by weight, based on the total amount of 1,3-diol and alkylene oxide.

Alkoxylation with x+y C₂-C₁₈ alkylene oxides and/or x₁+y₁ C₂-C₁₈ alkylene oxides produces structures as represented by Formula 2 and/or Formula 3:

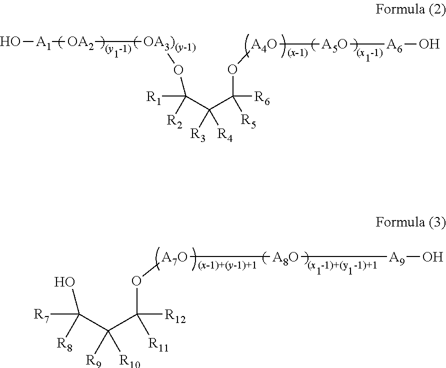

where R₁-R₁₂ are independently selected from H, alkyl, cycloalkyl, aryl, alkylaryl, or arylalkyl, where at least one of R₁-R₆ and at least one of R₇-R₁₂ is different from H, each of A₁-A₉ is independently selected from linear or branched alkylenes having 2 to 18 carbon atoms, typically 2-10 carbon atoms, more typically 2-5 carbon atoms, and the sum of x+y is in the range of about 2 to about 200, typically about 2 to about 20, more typically about 2 to about 10 or about 2 to about 5, where x≧1 and y≧1, and the sum of x₁+y₁ is in the range of about 2 to about 200, typically about 2 to about 20, more typically about 2 to about 10 or about 2 to about 5, where x₁≧1 and y₁≧1.

### Step b): Amination

Amination of the alkoxylated 1,3-diols produces structures represented by Formula I or Formula II:

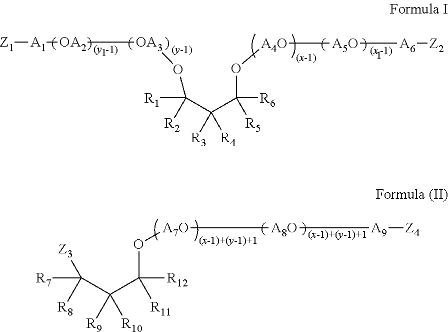

where each of R₁-R₁₂ is independently selected from H, alkyl, cycloalkyl, aryl, alkylaryl, or arylalkyl, where at least one of R₁-R₆ and at least one of R₇-R₁₂ is different from H, each of A₁-A₉ is independently selected from linear or branched alkylenes having 2 to 18 carbon atoms, typically 2-10 carbon atoms, more typically, 2-5 carbon atoms, each of Z₁-Z₄ is independently selected from OH or NH₂, where at least one of Z₁-Z₂ and at least one of Z₃-Z₄ is NH₂, where the sum of x+y is in the range of about 2 to about 200, typically about 2 to about 20, more typically about 2 to about 10 or about 2 to about 5, where x≧1 and y≧1, and the sum of x₁+y₁ is in the range of about 2 to about 200, typically about 2 to about 20, more typically about 2 to about 10 or about 2 to about 5, where x₁≧1 and y₁≧1.

Polyetheramines according to Formula I and/or Formula II are obtained by reductive amination of the alkoxylated 1,3-diol mixture (Formula 2 and Formula 3) with ammonia in the presence of hydrogen and a catalyst containing nickel. Suitable catalysts are described in WO 2011/067199A1, WO2011/067200A1, and EP0696572 B1. Preferred catalysts are supported copper-, nickel-, and cobalt-containing catalysts, where the catalytically active material of the catalyst, before the reduction thereof with hydrogen, comprises oxygen compounds of aluminum, copper, nickel, and cobalt, and, in the range of from about 0.2 to about 5.0% by weight of oxygen compounds, of tin, calculated as SnO. Other suitable catalysts are supported copper-, nickel-, and cobalt-containing catalysts, where the catalytically active material of the catalyst, before the reduction thereof with hydrogen, comprises oxygen compounds of aluminum, copper, nickel, cobalt and tin, and, in the range of from about 0.2 to about 5.0% by weight of oxygen compounds, of yttrium, lanthanum, cerium and/or hafnium, each calculated as Y₂O₃, La₂O₃, Ce₂O₃ and Hf₂O₃, respectively. Another suitable catalyst is a zirconium, copper, and nickel catalyst, where the catalytically active composition comprises from about 20 to about 85% by weight of oxygen-containing zirconium compounds, calculated as ZrO₂, from about 1 to about 30% by weight of oxygen-containing compounds of copper, calculated as CuO, from about 30 to about 70% by weight of oxygen-containing compounds of nickel, calculated as NiO, from about 0.1 to about 5% by weight of oxygen-containing compounds of aluminium and/or manganese, calculated as Al₂O₃ and MnO₂ respectively.

For the reductive amination step, a supported as well as non-supported catalyst may be used. The supported catalyst is obtained, for example, by deposition of the metallic components of the catalyst compositions onto support materials known to those skilled in the art, using techniques which are well-known in the art, including without limitation, known forms of alumina, silica, charcoal, carbon, graphite, clays, mordenites; and molecular sieves, to provide supported catalysts as well. When the catalyst is supported, the support particles of the catalyst may have any geometric shape, for example spheres, tablets, or cylinders, in a regular or irregular version. The process may be carried out in a continuous or discontinuous mode, e.g. in an autoclave, tube reactor, or fixed-bed reactor. The feed thereto may be upflowing or downflowing, and design features in the reactor which optimize plug flow in the reactor may be employed. The degree of amination is from about 50% to about 100%, typically from about 60% to about 100%, and more typically from about 70% to about 100%.

The degree of amination is calculated from the total amine value (AZ) divided by sum of the total acetylables value (AC) and tertiary amine value (tert. AZ) multiplied by 100: (Total AZ: (AC+tert. AZ))×100). The total amine value (AZ) is determined according to DIN 16945. The total acetylables value (AC) is determined according to DIN 53240. The secondary and tertiary amines are determined according to ASTM D2074-07.

The hydroxyl value is calculated from (total acetylables value+tertiary amine value)−total amine value. The polyetheramines of the invention are effective for removal of greasy soils, in particular removal of crystalline grease.

Especially preferred for use herein is a polyethylene amine of Formula (I) having the following structure of Formula (Ia):

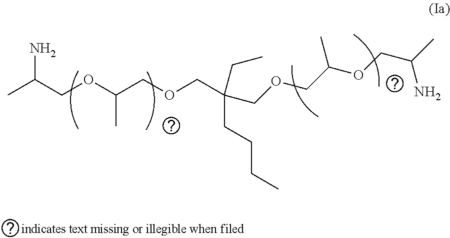

wherein n+m is from 0 to 8. Preferably n+m is from 0 to 6 and more preferably from 1 to 6.

The polyetheramine may be a polyetheramine of Formula (III),

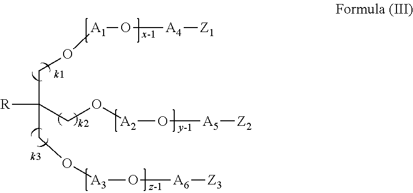

wherein
R is selected from H or a C1-C6 alkyl group,
each of k₁, k₂, and k₃ is independently selected from 0, 1, 2, 3, 4, 5, or 6,
each of A₁, A₂, A₃, A₄, A₅, and A₆ is independently selected from a linear or branched alkylene group having from about 2 to about 18 carbon atoms or mixtures thereof,
x≧1, y≧1, and z≧1, and the sum of x+y+z is in the range of from about 3 to about 100, and
each of Z₁, Z₂, and Z₃ is independently selected from NH₂ or OH, where at least two of Z₁, Z₂, and Z₃ are NH₂.

Preferably, R is H or a C1-C6 alkyl group selected from methyl, ethyl, or propyl. In some aspects, R is H or a C1-C6 alkyl group selected from ethyl.

Preferably, each of k₁, k₂, and k₃ is independently selected from 0, 1, or 2. Each of k₁, k₂, and k₃ may be independently selected from 0 or 1. More preferably, at least two of k₁, k₂, and k₃ are 1 and even more preferably, each of k₁, k₂, and k₃ is 1.

Preferably, each of Z₁, Z₂, and Z₃ is NH₂.

All A groups (i.e., A₁-A₆) may be the same, at least two A groups may be the same, at least two A groups may be different, or all A groups may be different from each other. Each of A₁, A₂, A₃, A₄, A₅, and A₆ may be independently selected from a linear or branched alkylene group having from about 2 to about 10 carbon atoms, or from about 2 to about 6 carbon atoms, or from about 2 to about 4 carbon atoms, or mixtures thereof. Preferably, at least one, or at least three, of A₁-A₆ is a linear or branched butylene group. More preferably, each of A₄, A₅, and A₆ is a linear or branched butylene group. Especially, each of A₁-A₆ is a linear or branched butylene group.

Preferably, x, y, and/or z are independently selected and should be equal to 3 or greater, meaning that that the polyetheramine may have more than one [A₁-O] group, more than one [A₂-O] group, and/or more than one [A₃-O] group. Preferably, A₁ is selected from ethylene, propylene, butylene, or mixtures thereof. Preferably, A₂ is selected from ethylene, propylene, butylene, or mixtures thereof. Preferably, A₃ is selected from ethylene, propylene, butylene, or mixtures thereof. When A₁, A₂, and/or A₃ are mixtures of ethylene, propylene, and/or butylenes, the resulting alkoxylate may have a block-wise structure or a random structure.

[A₁-O]ₓ₋₁ can be selected from ethylene oxide, propylene oxide, butylene oxide, or mixtures thereof. [A₂-O]_{y-1} can be selected from ethylene oxide, propylene oxide, butylene oxide, or mixtures thereof. [A₃-O]_{z-1} can be selected from ethylene oxide, propylene oxide, butylene oxide, or mixtures thereof.

Preferably, the sum of x+y+z is in the range of from about 3 to about 100, or from about 3 to about 30, or from about 3 to about 10, or from about 5 to about 10.

Typically, the polyetheramines of the present invention have a weight average molecular weight of from about 150, or from about 200, or from about 350, or from about 500 grams/mole, to about 1000, or to about 900, or to about 800 grams/mole.

Preferably, when the polyetheramine is a polyetheramine of Formula (III) where R is a C2 alkyl group (i.e., ethyl) and optionally each of k₁, k₂, and k₃ is 1, the molecular weight of the polyetheramine is from about 500 to about 1000, or to about 900, or to about 800 grams/mole. It is also preferred, when the polyetheramine is a polyetheramine of Formula (III) where R is a C2 alkyl group (i.e., ethyl) and optionally each of k₁, k₂, and k₃ is 1, at least one A group (i.e., at least one of A1, A2, A3, A4, A5, or A6) is not a propylene group. It is also preferred, when the polyetheramine is a polyetheramine of Formula (III) where R is a C2 alkyl group (i.e., ethyl) and optionally each of k₁, k₂, and k₃ is 1, at least one A group (i.e., at least one of A1, A2, A3, A4, A5, or A6) is a ethylene group or a butylene group, or more typically at least one A group (i.e., at least one of A1, A2, A3, A4, A5, or A6) is a butylene group.

Polyetheramine with the following structure are preferred for use herein:

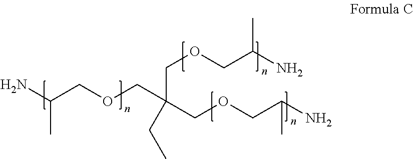

where average n is from about 0.5 to about 5, or from about 1 to about 3, or from about 1 to about 2.5.

Other preferred polyetheramines are selected from the group consisting of Formula C, Formula D, Formula E, and mixtures thereof:

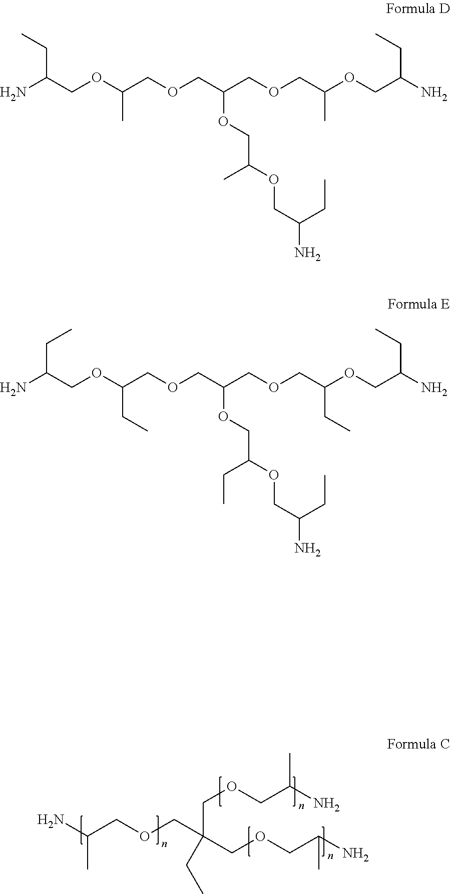

where average n is from about 0.5 to about 5.

The polyetheramines of Formula (III) of the present invention may be obtained by a process comprising the following steps:

a) reacting a low-molecular-weight, organic triol, such as glycerine and/or 1,1,1-trimethylolpropane, with C₂-C₁₈ alkylene oxide, to form an alkoxylated triol, where the molar ratio of the low-molecular-weight organic triol to the alkylene oxide is in the range of about 1:3 to about 1:10, and

b) aminating the alkoxylated triol with ammonia.

This process is described in more detail below.

### Alkoxylation

Polyetheramines according to Formula (III) may be obtained by reductive amination of an alkoxylated triol. Alkoxylated triols according to the present disclosure may be obtained by reaction of low-molecular-weight, organic triols, such as glycerine and/or 1,1,1-trimethylolpropane, with alkylene oxides according to general alkoxylation procedures known in the art.

By “low-molecular-weight,” it is meant that the triol has a molecular weight of from about 64 to about 500, or from about 64 to about 300, or from about 78 to about 200, or from about 92 to about 135 g/mol. The triol may be water soluble.

A low-molecular-weight, organic triol useful herein (or simply “low-molecular-weight triol,” as used herein) has the structure of Formula (4):

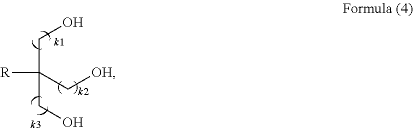

where R is selected from H or a C1-C6 alkyl group, and where each k is independently selected from 0, 1, 2, 3, 4, 5, or 6. Preferably, R is H or a C1-C6 alkyl group selected from methyl, ethyl, or propyl. More preferably, R is H or ethyl. k₁, k₂, and k₃ can each be independently selected from 0, 1, or 2. Each of k₁, k₂, and k₃ may be independently selected from 0 or 1. Preferably, at least two of k₁, k₂, and k₃ are 1. More preferably, all three of k₁, k₂, and k₃ are 1.

The low-molecular-weight triol can be selected from glycerine, 1,1,1-trimethylolpropane, or mixtures thereof.

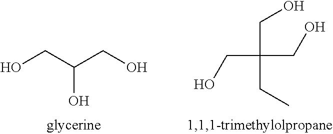

The alkoxylated triol, such as alkoxylated glycerine or alkoxylated 1,1,1-trimethylolpropane, may be prepared in a known manner by reaction of the low-molecular-weight triol with an alkylene oxide. Suitable alkylene oxides are linear or branched C₂-C₁₈ alkylene oxides, typically C₂-C₁₀ alkylene oxides, more typically C₂-C₆ alkylene oxides or C₂-C₄ alkylene oxides. Suitable alkylene oxides include ethylene oxide, propylene oxide, butylene oxide, pentene oxide, hexene oxide, decene oxide, and dodecene oxide. In some aspects, the C₂-C₁₈ alkylene oxide is selected from ethylene oxide, propylene oxide, butylene oxide, or a mixture thereof. In some aspects, the C₂-C₁₈ alkylene oxide is butylene oxide, optionally in combination with other C₂-C₁₈ alkylene oxides.

The low molecular weight triols, such as glycerine or 1,1,1-trimethylolpropane, may be reacted with one single type of alkylene oxide or combinations of two or more different types of alkylene oxides, e.g., ethylene oxide and propylene oxide. If two or more different types of alkylene oxides are used, the resulting alkoxylate may have a block-wise structure or a random structure.

Typically, the molar ratio of low-molecular-weight triol to C₂-C₁₈ alkylene oxide at which the alkoxylation reaction is carried out is in the range of about 1:3 to about 1:10, more typically about 1:3 to about 1:6, even more typically about 1:4 to about 1:6. In some aspects, the molar ratio of low-molecular-weight triol to C₂-C₁₈ alkylene oxide at which the alkoxylation reaction is carried out is in the range of about 1:5 to about 1:10.

When the low-molecular-weight triol is 1,1,1-trimethylolpropane, or when R of the triol of Formula (2) is a C2 alkyl and each of k₁, k₂, and k₃ are 1, the polyetheramine has a weight average molecular weight of from about 500 to about 1000, or to about 900, or to about 800 grams/mole.

The reaction is generally performed in the presence of a catalyst in an aqueous solution at a reaction temperature of from about 70° C. to about 200° C., and typically from about 80° C. to about 160° C. This reaction may be performed at a pressure of up to about 10 bar, or up to about 8 bar.

Examples of suitable catalysts are basic catalysts such as alkali metal and alkaline earth metal hydroxides, such as sodium hydroxide, potassium hydroxide and calcium hydroxide, alkali metal alkoxides, in particular sodium and potassium C₁-C₄-alkoxides, such as sodium methoxide, sodium ethoxide and potassium tert-butoxide, alkali metal and alkaline earth metal hydrides, such as sodium hydride and calcium hydride, and alkali metal carbonates, such as sodium carbonate and potassium carbonate. Alkali metal hydroxides, such as potassium hydroxide and sodium hydroxide, are particularly suitable. Typical use amounts for the basic catalyst are from about 0.05 to about 10% by weight, in particular from about 0.1 to about 2% by weight, based on the total amount of the low-molecular-weight triol and the alkylene oxide.

### Amination

Polyetheramines according to Formula (III) may be obtained by reductive amination of an alkoxylated triol, such as those described above, for example alkoxylated glycerine or alkoxylated 1,1,1-trimethylolpropane, with ammonia in the presence of hydrogen and a catalyst, such as a catalyst containing nickel. Suitable catalysts are described in WO 2011/067199 A1, in WO2011/067200 A1, and in EP0696572 B1.

The amination may be carried out in the presence of copper-, nickel- or cobalt-containing catalyst. Preferred catalysts are supported copper-, nickel- and cobalt-containing catalysts, wherein the catalytically active material of the catalysts, before the reduction thereof with hydrogen, comprises oxygen compounds of aluminium, copper, nickel and cobalt, and, in the range of from about 0.2% to about 5.0% by weight, of oxygen compounds of tin, calculated as SnO. Other preferred catalysts are supported copper-, nickel- and cobalt-containing catalysts, wherein the catalytically active material of the catalysts, before the reduction thereof with hydrogen, comprises oxygen compounds of aluminium, copper, nickel, cobalt, tin, and, in the range of from about 0.2 to about 5.0% by weight, of oxygen compounds of yttrium, lanthanum, cerium and/or hafnium, each calculated as Y₂O₃, La₂O₃, Ce₂O₃ and Hf₂O₃, respectively. Another suitable catalyst is a zirconium, copper, nickel catalyst, wherein the catalytically active composition comprises from about 20 to about 85% by weight of oxygen-containing zirconium compounds, calculated as ZrO₂, from about 1 to about 30% by weight of oxygen-containing compounds of copper, calculated as CuO, from about 30 to about 70% by weight of oxygen-containing compounds of nickel, calculated as NiO, from about 0.1 to about 5% by weight of oxygen-containing compounds of aluminium and/or manganese, calculated as Al₂O₃ and MnO₂, respectively.

For the reductive amination step, a supported as well as a non-supported catalyst can be used. The supported catalyst may be obtained by deposition of the metallic components of the catalyst compositions onto support materials known to those skilled in the art, using techniques that are well-known in the art, including, without limitation, known forms of alumina, silica, charcoal, carbon, graphite, clays, mordenites; molecular sieves may be used to provide supported catalysts as well. When the catalyst is supported, the support particles of the catalyst may have any geometric shape, for example, the shape of spheres, tablets, or cylinders in a regular or irregular version.

The process can be carried out in a continuous or discontinuous mode, e.g., in an autoclave, tube reactor, or fixed-bed reactor. A number of reactor designs may be used. For example, the feed thereto may be upflowing or downflowing, and design features in the reactor that optimize plug flow in the reactor may be employed.

The degree of amination may be from about 67% to about 100%, or from about 85% to about 100%. The degree of amination is calculated from the total amine value (AZ) divided by sum of the total acetylables value (AC) and tertiary amine value (tert. AZ) multiplied by 100 (Total AZ/((AC+tert. AZ)×100)).

The total amine value (AZ) is determined according to DIN 16945.

The total acetylables value (AC) is determined according to DIN 53240.

The secondary and tertiary amines are determined according to ASTM D2074-07.

The hydroxyl value is calculated from (total acetylables value+tertiary amine value)−total amine value.

### Amine of Formula (1):

The cleaning amine of Formula (1) has an ethylene diamine core with at least one primary amine functionality. The cleaning amine also comprises at least another nitrogen atom, preferable in the form of a tertiary amine functionality. Herein the term “core” refers to the alkyl chain between two nitrogen radicals. The number of carbons in the core does not include the radicals attached to the core.

The cleaning amine has the formula:

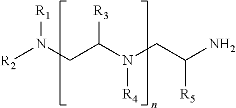

wherein: R₁, R₂, R₃, R₄, and R₅ are independently selected from —H, linear, branched or cyclic alkyl or alkenyl having from 1 to 10 carbon atoms and n=0-3.

Preferably, the cleaning amine is aliphatic in nature. The cleaning amine preferably has a molecular weight of less than about 1000 grams/mole and more preferably less than about 450 grams/mole.

“n” varies from 0 to not more than 3, preferably “n” is 0. The amine molecule contains at least one primary amine functionality and preferably a tertiary amine functionality.

Suitable cleaning amines for use herein include amines wherein R₁ and R₂ are selected from isopropyl and butyl, preferably R₁ and R₂ are both isopropyl or both butyl.

Preferably cleaning amines include those in which R1 and R2 are isopropyl and preferably, n is 0. Also preferred are amines in which R1 and R2 are butyl and preferably, n is 0

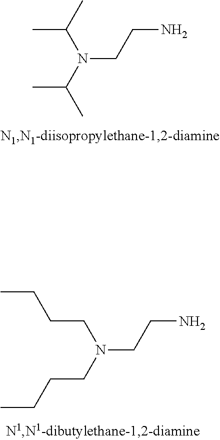

R5 is preferably —CH3 or —CH2CH3. Cleaning amines in which R5 is —CH3 or —CH2CH3 could be good in terms of composition stability. Without being bound by theory, it is believed that the methyl or ethyl radical can provide stearic hinderance that protects the cleaning amine from negative interaction with other components of the cleaning composition.

### Amine of Formula (2):

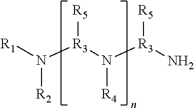 [0110] wherein R₁ and R₄ are independently selected from —H, linear, branched or cyclic alkyl or alkenyl; having from 1 to 10 carbon atoms and R₂ is a linear, branched or cyclic alkyl or alkenyl having from 3 to 10 carbons, R₃ is a linear or branched alkyl from 3 to 6 carbon atoms, R₅ is H, methyl or ethyl and is preferably located in alpha position from the amine functionality/ies, and n=0-3.

The cleaning amine of formula (2) has a C3-C6 diamine core with at least one of the amine functionalities being a primary amine. Herein the term “core” refers to the alkyl chain between two nitrogen radicals. The number of carbons in the core does not include the radicals attached to the core.

The cleaning amine of formula (2) preferably has a molecular weight of less than about 1000 grams/mole and more preferably less than about 450 grams/mole.

“n” varies from 0 to not more than 3, preferably “n” is 0. The amine molecule contains at least one primary amine functionality and preferably a tertiary amine functionality.

Suitable cleaning amines include amines wherein R₁ and R₂ are selected from propyl, butyl and hexyl, preferably R₁ and R₂ are both propyl, butyl or hexyl. Preferably n is 0.

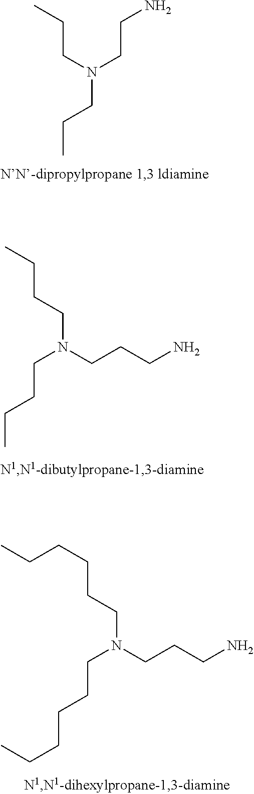

Another preferred cleaning amine for use herein is cyclohexyl propylenediamine (wherein n=0, R1 is cyclohexanyl and R2 is H)

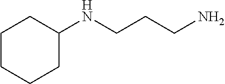 [SMILES: NCCCNC1CCCCC1]

Especially preferred for use herein is the amine of Formula (3)

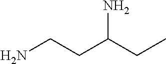

Nonionic surfactant, when present, is comprised in an amount of less than 2%, preferably less than 1% by weight of the composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol. Highly preferred nonionic surfactants are the condensation products of guerbet alcohols with from 2 to 18 moles, preferably 2 to 15, more preferably 5-12 of ethylene oxide per mole of alcohol.

### Zwitterionic Surfactant

Other suitable surfactants include betaines, such as alkyl betaines, alkylamidobetaine, amidazoliniumbetaine, sulfobetaine (INCI Sultaines) as well as the Phosphobetaine and preferably meets formula I:

R¹—[CO—X(CH₂)ₙ]ₓ—N+(R²)(R₃)—(CH₂)ₘ—[CH(OH)—CH₂]_{y}—Y— (I) wherein
R¹ is a saturated or unsaturated C6-22 alkyl residue, preferably C8-18 alkyl residue, in particular a saturated C10-16 alkyl residue, for example a saturated C12-14 alkyl residue;
X is NH, NR⁴ with C1-4 Alkyl residue R⁴, O or S,
n a number from 1 to 10, preferably 2 to 5, in particular 3,
x 0 or 1, preferably 1,
R², R³ are independently a C1-4 alkyl residue, potentially hydroxy substituted such as a hydroxyethyl, preferably a methyl.
m a number from 1 to 4, in particular 1, 2 or 3,
y 0 or 1 and
Y is COO, SO3, OPO(OR⁵)O or P(O)(OR⁵)O, whereby R⁵ is a hydrogen atom H or a C1-4 alkyl residue.

Preferred betaines are the alkyl betaines of the formula (Ia), the alkyl amido propyl betaine of the formula (Ib), the Sulfo betaines of the formula (Ic) and the Amido sulfobetaine of the formula (Id);

R¹—N⁺(CH₃)₂—CH₂COO⁻ (Ia)

R¹—CO—NH(CH₂)₃—N⁺(CH₃)₂—CH₂COO⁻¹ (Ib)

R¹—N⁺(CH₃)₂—CH₂CH(OH)CH₂SO₃— (Ic)

R¹—CO—NH—(CH₂)₃—N⁺(CH₃)₂—CH₂CH(OH)CH₂SO₃— (Id)

in which R¹1 as the same meaning as in formula I. Particularly preferred betaines are the Carbobetaine [wherein Y⁻═COO⁻], in particular the Carbobetaine of the formula (Ia) and (Ib), more preferred are the Alkylamidobetaine of the formula (Ib).

Examples of suitable betaines and sulfobetaine are the following [designated in accordance with INCI]: Almondamidopropyl of betaines, Apricotam idopropyl betaines, Avocadamidopropyl of betaines, Babassuamidopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, Milkam idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines.

### A Preferred Betaine is, for Example, Cocoamidopropylbetain.

The detergent composition herein may comprise a number of optional ingredients such as builders, chelants, conditioning polymers, cleaning polymers, surface modifying polymers, soil flocculating polymers, structurants, rheology modifiers, emmolients, humectants, skin rejuvenating actives, enzymes, carboxylic acids, scrubbing particles, bleach and bleach activators, perfumes, malodor control agents, pigments, dyes, opacifiers, beads, pearlescent particles, microcapsules, organic solvents, hydrotropes, inorganic cations such as alkaline earth metals such as Ca/Mg-ions, antibacterial agents, preservatives, anti-oxidants and pH adjusters and buffering means.

### Method of Washing

Other aspects of the invention are directed to a method of washing dishware with the composition of the present invention.

The composition herein can be applied in its diluted form. Soiled dishes are contacted with an effective amount, typically from about 0.5 ml to about 20 ml (per about 25 dishes being treated), preferably from about 3 ml to about 10 ml, of the detergent composition, preferably in liquid form, of the present invention diluted in water. The actual amount of detergent composition used will be based on the judgment of user, and will typically depend upon factors such as the particular product formulation of the composition, including the concentration of active ingredients in the composition, the number of soiled dishes to be cleaned, the degree of soiling on the dishes, and the like. Generally, from about 0.01 ml to about 150 ml, preferably from about 3 ml to about 40 ml of a liquid detergent composition of the invention is combined with from about 2000 ml to about 20000 ml, more typically from about 5000 ml to about 15000 ml of water in a sink having a volumetric capacity in the range of from about 1000 ml to about 20000 ml, more typically from about 5000 ml to about 15000 ml. The soiled dishes are immersed in the sink containing the diluted compositions then obtained, where contacting the soiled surface of the dish with a cloth, sponge, or similar article cleans them. The cloth, sponge, or similar article may be immersed in the detergent composition and water mixture prior to being contacted with the dish surface, and is typically contacted with the dish surface for a period of time ranged from about 1 to about 10 seconds, although the actual time will vary with each application and user. The contacting of cloth, sponge, or similar article to the dish surface is preferably accompanied by a concurrent scrubbing of the dish surface.

Another method may comprise immersing the soiled dishes into a water bath or held under running water without any liquid dishwashing detergent. A device for absorbing liquid dishwashing detergent, such as a sponge, is placed directly into contact with a separate quantity of undiluted liquid dishwashing composition for a period of time typically ranging from about 1 to about 5 seconds. The absorbing device, and consequently the undiluted liquid dishwashing composition, is then contacted individually to the surface of each of the soiled dishes to remove said soiling. The absorbing device is typically contacted with each dish surface for a period of time range from about 1 to about 10 seconds, although the actual time of application will be dependent upon factors such as the degree of soiling of the dish. The contacting of the absorbing device to the dish surface is preferably accompanied by concurrent scrubbing.

Alternatively, the device may be immersed in a mixture of the hand dishwashing composition and water prior to being contacted with the dish surface, the concentrated solution is made by diluting the hand dishwashing composition with water in a small container that can accommodate the cleaning device at weight ratios ranging from about 95:5 to about 5:95, preferably about 80:20 to about 20:80 and more preferably about 70:30 to about 30:70, respectively, of hand dishwashing liquid:water respectively depending upon the user habits and the cleaning task.

### Examples

The table below exemplifies a hand dishwashing cleaning product according to the invention.

| % active by | | | | |
|---|---|---|---|---|
| weight of the | Example | Example | Example | Example |
| composition | A | B | C | D |
| C1213 alkyl | 23.1% | 23.1% | 23.1% | 23.1% |
| ethoxy (0.6) | | | | |
| sulfate (AES) | | | | |
| C1214 | 0.45% | 0.45% | 0.45% | 0.45% |
| dimethyl | | | | |
| amine oxide | | | | |
| C10 dimethyl | 2.0% | 2.0% | 2.0% | 2.0% |
| amine oxide | | | | |
| Lutensol XP80 | 0.46% | 0.46% | 0.46% | 0.46% |
| Polyetheramine | 1% | — | — | — |
| A or B | | | | |
| N1,N1- | — | 1.5% | — | — |
| diisopropyl- | | | | |
| ethane- | | | | |
| 1,2-diamine | | | | |
| N1,N1- | — | — | 2% | — |
| dipropyl- | | | | |
| propane- | | | | |
| 1,3-diamine | | | | |
| Pentane-1,3- | — | — | — | 1.5% |
| diamine | | | | |
| NaCl | 1.2% | 1.2% | 1.2% | 1.2% |
| Polypropylene- | 1.6% | 1.6% | 1.6% | 1.6% |
| glycol | | | | |
| (MW 2000) | | | | |
| Ethanol | 5.7% | 5.7% | 5.7% | 5.7% |
| pH (10% | 8 | 8 | 8 | 8 |
| dilution in | | | | |
| demi water | | | | |
| at 20° C.) - | | | | |
| with NaOH | | | | |
| Water and | To 100% | To 100% | To 100% | To 100% |
| minors (dye, | | | | |
| perfume, | | | | |
| preservative) | | | | |

C1213 alkyl ethoxy (0.6) sulfate (AES): C12-13 alkyl ethoxy sulfate with an average degree of ethoxylation of 0.6
Lutensol XP80: Non-ionic surfactant available from BASF

### Polyetheramines According to Formula A or Formula B:

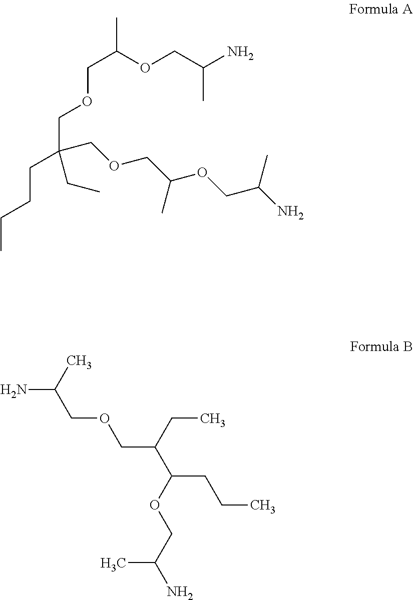 [SMILES: CCCCC(CC)(COCC(C)OCC(C)N)COCC(C)OCC(C)N ; CCCC(OCC(C)N)C(CC)COCC(C)N]

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A hand dishwashing detergent composition comprising anionic surfactant and an amine oxide surfactant comprising a low-cut amine oxide of formula RaRbRcAO wherein Ra and Rb are independently selected from hydrogen, C1-C4 alkyls or mixtures thereof and wherein Rc is selected from C10 alkyls or mixtures thereof, and a cleaning amine selected from the group consisting of:
i. polyetheramines of Formula (I), Formula (II), or Formula (III): 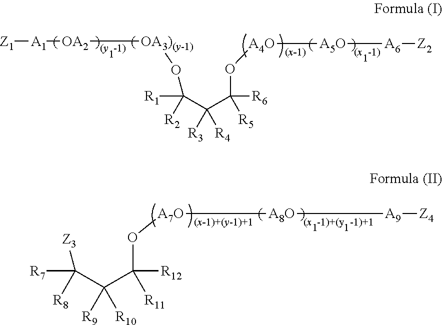
wherein each of R₁-R₁₂ is independently selected from H, alkyl, cycloalkyl, aryl, alkylaryl, or arylalkyl, wherein at least one of R₁-R₆ and at least one of R₇-R₁₂ is different from H, each of A₁-A₉ is independently selected from linear or branched alkylenes having 2 to 18 carbon atoms, each of Z₁-Z₄ is independently selected from OH or NH₂, wherein at least one of Z₁-Z₂ and at least one of Z₃-Z₄ is NH₂, wherein the sum of x+y is in the range of about 2 to about 200, wherein x≧1 and y≧1, and the sum of x₁+y₁ is in the range of about 2 to about 200, wherein x₁≧1 and y₁≧1; 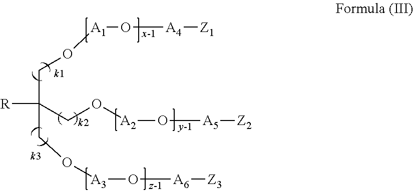
wherein
R is selected from H or a C1-C6 alkyl group, each of k₁, k₂, and k₃ is independently selected from 0, 1, 2, 3, 4, 5, or 6, each of A₁, A₂, A₃, A₄, A₅, and A₆ is independently selected from a linear or branched alkylene group having from 2 to 18 carbon atoms or mixtures thereof, x≧1, y≧1, and z≧1, and the sum of x+y+z is in the range of from about 3 to about 100, each of Z₁, Z₂, and Z₃ is independently selected from NH₂ or OH, where at least two of Z₁, Z₂, and Z₃ are NH₂; and the polyetheramine has a weight average molecular weight of from about 150 to about 1000 grams/mole;
ii. amines of Formula (1): 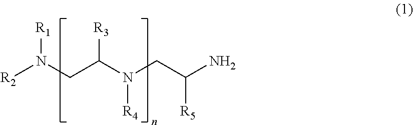
wherein: R₁, R₂, R₃, R₄, and R₅ are independently selected from —H, linear, branched or cyclic alkyl or alkenyl having from 1 to 10 carbon atoms and n=0-3;
iii. amines of Formula (2): 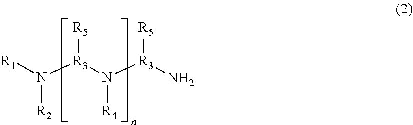
wherein: R₁ and R₄ are independently selected from —H, linear, branched or cyclic alkyl or alkenyl having from 1 to 10 carbon atoms; and R₂ is a linear, branched or cyclic alkyl or alkenyl having from 3 to 10 carbons, R₃ is a linear or branched alkyl from 3 to 6 carbon atoms, R₅ is H, methyl or ethyl and n=0-3;
iv. the amine of Formula (3): 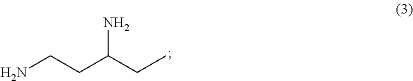
and
v. mixtures thereof.

2. The composition according to claim 1 comprising from about 1% to about 15% by weight of the composition of the amine oxide.

3. The composition according to claim 1 comprising from about 10% to about 100% by weight of the amine oxide of the low-cut amine oxide.

4. The composition according to claim 1 comprising from about 0% to about 90% by weight of the amine oxide of a mid-cut amine oxide of formula RdReRfAO wherein Rd and Re are independently selected from hydrogen, C1-C4 alkyls or mixtures thereof and wherein Rf is selected from C12-C16 alkyls or mixtures thereof.

5. The composition according to claim 1 comprising from about 0.1 to about 5% by weight of the composition of the cleaning amine.

6. The composition according to claim 5 comprising from about 0.1 to about 2% by weight of the composition of the cleaning amine.

7. The composition according to claim 1 wherein in said polyetheramine of Formula (I) or Formula (II), each of A₁-A₉ is independently selected from ethylene, propylene, or butylene.

8. The composition according to claim 7 wherein in said polyetheramine of Formula (I) or Formula (II), each of A₁-A₉ is propylene.

9. The composition according to claim 1 wherein the polyetheramine of Formula (I) has the following Formula (Ia): 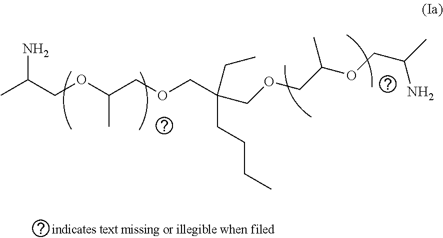
wherein n+m is from 0 to 8.

10. The composition according to claim 1 comprising from about 1 to about 15% by weight of the composition of the amine oxide surfactant wherein the amine oxide surfactant comprises:
a) from about 10% to about 100% by weight of the amine oxide of the low-cut amine oxide of formula RaRbRcAO wherein Ra and Rb are both methyls and Rc is n-decyl;
b) from about 0% to about 90% by weight of the amine oxide of a mid-cut amine oxide of formula RdReRfAO wherein Rd and Re are independently selected from hydrogen, C1-C4 alkyls or mixtures thereof and wherein Rf is selected from C12-C16 alkyls or mixtures thereof.

11. The composition according to claim 1 comprising less than about 5%, by weight of the amine oxide of an amine oxide of formula RgRhRiAO wherein Rg and Rh are independently selected from hydrogen, C1-C4 alkyls or mixtures thereof and wherein Ri is selected from C8 alkyls or mixtures thereof.

12. The composition according to claim 11 comprising less than about 3% by weight of the amine oxide of an amine oxide of formula RgRhRiAO wherein Rg and Rh are independently selected from hydrogen, C1-C4 alkyls or mixtures thereof and wherein Ri is selected from C8 alkyls or mixtures thereof.

13. The composition according to claim 1 wherein the anionic surfactant comprises a sulphate anionic surfactant.

14. The composition according to claim 13 wherein the sulphate anionic surfactant is an alkyl sulphate, an alkoxylated sulphate or mixtures thereof.

15. The composition according to claim 14 wherein the alkoxylated sulphate has an average alkoxylation degree of from about 0.2 to about 3.

16. The composition according to claim 1 wherein the amount of anionic surfactant is from about 10% to about 40% by weight of the composition.

17. The composition according to claim 1 wherein the weight ratio of the anionic surfactant to the amine oxide surfactant is from about 1:1 to about 10:1.

18. The composition according to claim 1 wherein the composition comprises less than 2% by weight of the composition of nonionic surfactant.

19. A process for making a hand dishwashing detergent composition comprising a low-cut and mid-cut amine oxide according to claim 4 comprising the step of delivering the low-cut and mid-cut amine oxide from different feed stocks.
